(19) United States
(12) Patent Application Publication
(10) Pub. No.: US 2012/0328787 A1
(43) Pub. Date: Dec. 27, 2012

(54) HYDROSILYLATION REACTION INHIBITORS, AND USE THEREOF IN A COATING METHOD

(75) Inventors: Sébastien Marrot, Lyon (FR); Yassine Maadadi, Meyzieu (FR)

(73) Assignee: BLUESTAR SILICONES FRANCE, Lyon (FR)

(21) Appl. No.: 13/518,625

(22) PCT Filed: Dec. 20, 2010
(86) PCT No.: PCT/EP2010/070197

§ 371 Date: Sep. 10, 2012

(30) Foreign Application Priority Data
Dec. 23, 2009 (FR) 09 06316

(51) Int. Cl. B05D 7/00; B05D 7/02; B05D 7/14

(52) U.S. Cl. 427/387

(57) ABSTRACT

The present invention relates to the use of inhibiting compounds, in particular those suitable for inhibiting the hardening of a silicone elastomer precursor silicone composition obtained by a hydrosilylation reaction.

The present invention relates to a coating method in which hydrosilylation reaction inhibiting compounds are used.

When it is necessary to increase the pot life of addition-hardenable organopolysiloxane compositions, or to provide an addition-hardenable organopolysiloxane composition with a single component, it is customary to incorporate a hardening inhibitor. Hardening inhibitors are compounds which slow hardening at ambient temperatures, but which do not slow hardening at higher temperatures. These hardening inhibitors are sufficiently volatile to be expelled from coating compositions.

It is known, see for example U.S. Pat. No. 3,445,420, to use acetylenic compounds such as acetylenic alcohols having a boiling point of less than 250° C., especially 2-methyl-3-butyn-2-ol and ethynylcyclohexanol, as hydrosilylation inhibitors in hardenable silicone compositions based on an organosilicon polymer bearing substituents with an olefin (especially vinyl) unsaturation, an organohydrogenosiloxane polymer and a catalyst of the platinum or platinum compound type.

The presence of these acetylenic compounds inhibits the platinum catalyst by preventing it from catalyzing the hardening reaction at ambient temperature, but not at high temperature. Indeed, hardenable silicone compositions which contain this type of inhibitor may be hardened by increasing the temperature of the composition to a temperature greater than the boiling or sublimation point of the inhibitor, by thus evaporating the inhibitor, or a portion of the inhibitor, and by allowing the catalyst to catalyze the hydrosilylation reaction and consequently to harden the silicone composition.

The usefulness of these compositions is recognized and makes it possible to transport the compositions in a single packaging instead of two. They may also serve to extend the period of use or the pot life, compared with compositions not containing the acetylenic compound.

It is known to use stabilizers with polyaddition reaction inhibitors. Mention may be made for example of a silylated ester of phosphoric acid which is sold under the name “SOL 110” or “SOLUTION 110” by the company Bluestar Silicones (formerly Rhodia Silicones and earlier still Rhone-Poulenc Silicones). This stabilizer is mentioned for example in application US-2005-0282453 (page 12, paragraph [0268]) or international application WO1999005231 (page 13, line 13).

These compositions may be deposited on supports such as paper, by coating for example, and thermally hardened at a temperature of the order of 80 to 250° C., in particular between 100 and 220° C.; see for example patents FR-A-1 528 464 and FR-A-2 372 874.

These compositions have the disadvantage, for the preparation of antiadhesive coatings, of not being able to crosslink on the support at a temperature of less than 80° C. and of exhibiting insufficient stability during machine coating, gelling of the coating bath already manifesting itself after one hour. This is due to the fact that these inhibitors are sublimable. This major disadvantage requires using them in a large quantity, which results in a strong inhibition of the activity of the platinum and consequently in slowing of the speed of crosslinking, which necessitates reducing the rates of coating.

It therefore has to be said that previous technical proposals do not provide satisfactory solutions to the problem set out above.

One of the main objectives of the present invention is to provide a method of coating on a flexible support using a silicone composition X capable of hardening by polyaddition reaction, which is:
stable for several hours during machine coating operations;
crosslinks rapidly on a flexible support at a hardening temperature of less than 80° C., preferably even less than 75° C.;
exhibiting high bath stability at 40° C., and
optionally capable of containing lower quantities of hydrosilylation catalyst, given that a large quantity of inhibitor is no longer necessary.

Thus, the main subject of the invention consists of a method of coating on a flexible support S of a silicone composition X that is a precursor for an elastomer and that is crosslinkable by polyaddition reactions comprising the following steps a), b) and c):

a) a silicone composition X is prepared that is crosslinkable to an elastomer by polyaddition reactions, comprising:
(1) at least one organopolysiloxane A comprising per molecule at least two alkenyl radicals bonded to silicon atoms,
(2) at least one organohydrogenopolysiloxane B comprising per molecule at least two hydrogen atoms bonded to silicon atoms,
(3) at least one catalyst C composed of at least one metal belonging to the platinum group,
(4) at least one inhibitor D which is capable of being obtained by mixing, optionally in situ:
   at least one inhibitor D1 which is an α-acetylenic alcohol of the following formula (1):

(R¹)(R²)C(OH)—C≡CH (1)
the radicals R¹ and R², which are identical or different, represent, independently of each other, a linear or branched monovalent alkyl group, a cycloalkyl group, a (cycloalkyl)alkyl group, an aromatic group or an arylalkyl group, and
the radicals R¹ and R² may be bonded two by two so as to form a 5-, 6-, 7- or 8-membered aliphatic ring optionally substituted with one or more substituents, and
at least one acid D2 which exhibits in aqueous solution at 25° C. at least a pKa whose value is within the following interval −0.9≦pKa≦6.5,
said constituents D1 and D2 being initially present in said silicone composition X in sufficient quantities to:
   maintain the inhibition of the catalyst C so as to avoid the formation of a gel or of an elastomer when said silicone composition X is stored at ambient temperature, and
   allow the partial or complete degradation of said acetylenic alcohol D1 by a chemical reaction between the inhibitor D1 and the acid D2 when the silicone composition X is hardened by heating to a temperature greater than 60° C., and
on the additional condition that said silicone composition X does not contain water or enough water so as not to exist in the form of an aqueous silicone dispersion or emulsion,
   b) then said silicone composition X is deposited continuously or batchwise on said flexible support S, and
   c) the silicone composition X is crosslinked by heating to a temperature greater than 60° C., preferably of between 70° C. and 200° C.

The applicant has found quite unexpectedly, which is precisely what constitutes the subject of the present invention, that the use, as hydrosilylation inhibitor in compositions of the same type, of a mixture of an inhibitor D1 which is an α-acetylenic alcohol of formula (1) with an acid D2 exhibiting in aqueous solution and at 25° C. at least a pKa whose value is within the following interval −0.9≦pKa≦6.5, makes it possible to obtain compositions for the coating of a flexible support:
that are stable for several hours during machine coating operations;
that crosslink rapidly on a support at a hardening temperature of less than 90° C.,
that exhibit good bath stability at 40° C., and
that may optionally contain lower quantities of hydrosilylation catalyst, given that a large quantity of inhibitor is no longer necessary.

The definition of the acid D2 according to the invention does not comprise a silylated ester of phosphoric acid which is sold under the name “SOL 110” or “SOLUTION 110” by the company Bluestar Silicones (formerly Rhodia Silicones and earlier still Rhone-Poulenc Silicones) and as mentioned for example in application US-2005-0282453 (page 12, paragraph [0268]) or international application WO1999005231 (page 13, line 13).

According to a preferred embodiment, the flexible support S is made of paper, of textile, of cardboard, of metal or of plastic.

Preferably, the flexible support S is made of textile, of paper, of polyvinyl chloride (PVC), of polyester, of polypropylene, of polyamide, of polyethylene, of polyurethane, of unwoven glass fiber tissues or of polyethylene terephthalate (PET).

It is advantageous to choose the acid D2 from acids exhibiting in aqueous solution and at 25° C. at least a pKa whose value is within the following interval −0.9 pKa≦6.5 and from the group consisting of carboxylic acids, sulfonic acids and phosphoric acids.

Examples of acid D2 which are useful according to the invention are chosen for example from the group consisting of the following acids:
methanoic acid, ethanoic acid, propanoic acid, butanoic acid, pentanoic acid, hexanoic acid, heptanoic acid, octanoic acid, nonanoic acid, decanoic acid, dodecanoic acid, hexadecanoic acid, octadecanoic acid, benzoic acid, ethanedioic acid, 1,3-propanedioic acid, 1,4-butanedioic acid, 1,5-pentanedioic acid, 1,6-hexanedioic acid, benzenecarboxylic acid, cyclopentanecarboxylic acid, para-aminobenzoic acid, adipic acid, ortho-aminobenzoic acid, benzoic acid, citric acid, lactic acid, maleic acid, malic acid, malonic acid, mandelic acid, pyruvic acid, salicylic acid, succinic acid, oxalic acid, glutaric acid, phthalic acid, benzene-1,4-dicarboxylic acid, picric acid, pimelic acid, fumaric acid, pimelic acid, glycolic acid, sebacic acid, chloroethanoic acid, dichloroethanoic acid, trifluoroacetic acid, trichloroacetic acid, orthophosphoric acid, orthophosphorous acid, periodic acid, sulfuric acid, tartaric acid, sulfurous acid, thiocyanic acid, thiosulfuric acid, ascorbic acid and dichloroethanoic acid.

According to another preferred embodiment, the acid D2 is chosen from the group consisting of: methanoic acid, orthophosphoric acid, heptanoic acid, trifluoroacetic acid and malonic acid.

Preferably, the [inhibitor D1]/[acid D2] molar ratio is between 0.1 and 10, preferably between 0.5 and 5.

It is advantageous for the [inhibitor D1]/[catalyst C] molar ratio to be between 10 and 60 and for the [acid D2]/[catalyst C] molar ratio to be between 10 and 60.

An inhibitor D1 which is a useful α-acetylenic alcohol according to the invention may be chosen from the group consisting of the following compounds:
1-ethynyl-1-cyclopentanol; 1-ethynyl-1-cyclohexanol; 1-ethynyl-1-cycloheptanol; 1-ethynyl-1-cyclooctanol; 3-methyl-1-butyn-3-ol; 3-methyl-1-pentyn-3-ol; 3-methyl-1-hexyn-3-ol; 3-methyl-1-heptyn-3-ol; 3-methyl-1-octyn-3-ol; 3-methyl-1-nonyl-3-ol; 3-methyl-1-decyn-3-ol; 3-methyl-1-dodecyn-3-ol; 3-ethyl-1-pentyn-3-ol; 3-ethyl-1-hexyn-3-ol; 3-ethyl-1-heptyn-3-ol; 3-Butyn-2-ol; 1-pentyn-3-ol; 1-hexyn-3-ol; 1-heptyn-3-ol; 5-methyl-1-hexyn-3-ol; 3,5-dimethyl-1-hexyn-3-ol; 3-isobutyl-5-methyl-1-hexyn-3-ol; 3,4,4-trimethyl-1-pentyn-3-ol; 3-ethyl-5-methyl-1-heptyn-3-ol; 4-ethyl-1-octyn-3-ol; 3,7,11-trimethyl-1-dodecyn-3-ol; 1,1-diphenyl-2-propyn-1-ol and 9-ethynyl-9-fluorenol.

According to a variant of the invention, the proportions of the organopolysiloxane A and of the organohydrogenopolysiloxane B are such that the molar ratio between the hydrogen atoms bonded to the silicon in the organohydrogenopolysiloxane B on the acetylene radicals bonded to the silicon in the organopolysiloxane A is between 0.4 and 10.

Advantageously, the organopolysiloxane A according to the invention has:
at least two siloxyl units of formula (A.1):

TₐZ_{b}SiO_{4-(a+b)/2} (A.1)
in which:
   T is an alkenyl group,
   Z is a monovalent hydrocarbon group, having no unfavorable action on the activity of the catalyst and chosen from the group consisting of alkyl groups having from 1 to 8 carbon atoms inclusive, optionally substituted with at least one halogen atom, and aryl groups, and
   a is equal to 1 or 2, b is equal to 0, 1 or 2, and the sum a+b is between 1 and 3, and
optionally at least some of the other siloxyl units are units of formula (A.2):

Z_{c}SiO_{4-c/2} (A.2)
in which:
   Z has the same meaning as above and c is equal to 0, 1, 2 or 3.

In general, the organopolysiloxane A has a viscosity at least equal to 100 mPa·s and preferably less than 200 000 mPa·s.

Advantageously, the organohydrogenopolysiloxane according to the invention has:
at least two, and preferably at least three, siloxyl units of formula (B.1):

H_{d}LₑSiO_{4-(d+e)/2} (B.1)
in which:
   L is a monovalent hydrocarbon group, having no unfavorable action on the activity of the catalyst and chosen from the group consisting of alkyls having from 1 to 8 carbon atoms inclusive, optionally substituted with at least one halogen atom, and aryls,
   H is a hydrogen atom, and
   d is equal to 1 or 2, e is equal to 0, 1 or 2, the sum d+e is equal to 1, 2 or 3, and
optionally at least some of the other siloxyl units are units of formula (B.2):

L_{g}SiO_{4-g/2} (B.2)
in which:
   L has the same meaning as above and g is equal to 0, 1, 2 or 3.

In general, the dynamic viscosity of the organohydrogenopolysiloxane B is at least equal to 10 mPa·s and preferably it is between 20 and 1000 mPa·s.

Advantageously, the proportions of the siloxyl units (A.1) and (B.1) are such that the molar ratio between the hydrogen atoms bonded to the silicon in the organohydrogenopolysiloxane B on the alkenyl radicals bonded to the silicon in the organopolysiloxane A is between 0.4 and 10.

According to a variant of the invention, the silicone composition X may comprise one or more conventional additives in the field of silicone antiadhesive coatings for a solid support, for example made of paper. This may be for example an antimisting additive such as silica particles, or branched polyorganosiloxanes, and the like.

According to one variant, the silicone composition X may also comprise an adhesion-modulating system as well as customary additives in this type of application such as: bactericides, antigelling agents, wetting agents, antifoaming agents, fillers, synthetic latexes or colorants.

According to a preferred embodiment of the method according to the invention, in step b), a quantity of between 0.1 and 5 g/m² of the silicone composition X is deposited on the flexible support S.

The silicone composition X may be applied with the aid of devices used on industrial machines for coating paper, such as a five-roll coating head, air knife or smoothing rod systems, on flexible supports or materials, and then hardened by circulating through heated tunnel ovens at temperatures generally of between 70 and 200° C.; the passage time through these ovens depends on the temperature; it is generally of the order of 5 to 15 seconds at a temperature of the order of 100° C. and of the order of 1.5 to 3 seconds at a temperature of the order of 180° C.

The silicone composition X may be deposited on any flexible support such as paper of various types (supercalendered, coated, glassine), cardboard, cellulose sheets, metal sheets, plastic films (polyester, polyethylene, polypropylene and the like).

The quantities of compositions deposited are in general of the order of 0.1 to 5 g per m² of surface to be treated, which corresponds to the deposition of layers of the order of 0.1 to 5 μm.

The materials or supports thus coated may subsequently be brought into contact with any adhesive materials, rubber, acrylic or the like, which are sensitive to pressure. The adhesive material is then easily detachable from said support or material.

All the viscosities referred to in the present specification correspond to a dynamic viscosity parameter which is measured, in a manner known per se, at 25° C.

In the remainder of the present application, the polyorganosiloxane oils will be conventionally described with the aid of the customary notation in which the letters M, D, T and Q are used to denote various siloxyl units. In this notation, the silicon atom of a siloxyl unit is engaged in one (M), two (D), three (T) or four (Q) covalent bonds with as many oxygen atoms. When an oxygen atom is shared between two silicon atoms, it is counted as and it will not be mentioned in an abbreviated formula. On the other hand, if the oxygen atom belongs to an alkoxyl or hydroxyl group bonded to a silicon atom, this chemical function will be indicated in brackets in the abbreviated formula. By default, it is considered that the remaining bonds of the silicon atom are engaged with a carbon atom. Generally, the hydrocarbon groups bonded to the silicon by a C—Si bond are not mentioned and most often correspond to an alkyl group, for example a methyl group. When a hydrocarbon group has a particular function, it is indicated in superscript. For example, the abbreviated formulae:
M^{Vi} represents a unit in which the silicon atom is bonded to an oxygen atom and one of whose hydrocarbon groups forming a C—Si bond is a vinyl group, that is to say a dialkylvinylsiloxyl unit, and
M′ represents a unit in which the silicon atom is bonded to a hydrogen atom, to an atom and to two methyl groups.

By way of a reference manual, mention may be made of: NOLL “Chemistry and technology of silicones”, chapter 1.1, page 1-9, Academic Press, 1968-2nd edition.

The nonlimiting examples which follow will make it possible to understand the invention better and to gather therefrom all its advantages and variant embodiments.

### EXAMPLES

### Products Used

The pKa values are those measured in aqueous solution and at 25° C.
Vinylated polydimethylsiloxane oil end of chain (A.1): of average formula M^{vi}D₇₅M^{vi} and of viscosity at 25° C.=100 mPa·s.
Vinylated polydimethylsiloxane oil end of chain (A.2): of average formula M^{vi}D₁₁₀D^{vi}M^{vi}.
Polymethylhydrogenosiloxane oil (B.1): of average formula MD′₁₀D₁₀M.
Polymethylhydrogenosiloxane oils (B.2): mixture: 18% by weight of an oil of average formula M_{1.4}D′₁₄D₂₁M_{0.6}+82% of a polymethylhydrogenosiloxane oil of structure MD′₄₀M.
Catalyst (C): Karstedt Pt containing 2800 ppm of Pt.

Inhibitors According to the Invention:

(D1.I1): 1-ethynyl-1-cyclohexanol (ECH)
(D1-I2): 3,7,11-trimethyl-1-dodecyn-3-ol (TMDDO)

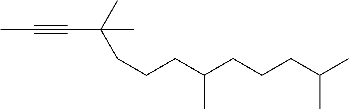

(D1.I3): 2-methyl-3-butyn-2-ol (MBT)

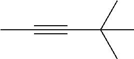

Comparative Inhibitors:

(D1.C1): diallyl maleate (DAM)

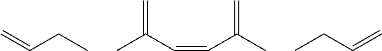

(D1.C2): tetramethyltetravinylcyclotetrasiloxane (D₄^{vi}).

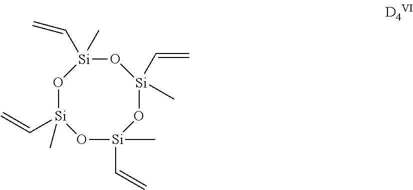

Acids for Trials According to the Invention:
trifluoroacetic acid (D2.I1): CF₃COOH; (pK1=: 0.23).
heptanoic acid (D2.I2): CH₃(CH₂)₅COOH, (pK1=: 4.89).
orthophosphoric acid (D2.I3): (H₃PO₄) (pK1=2.15).
malonic acid (as a solution in isopropylic alcohol) (D2.14): (pK1=2.85).

Acids for Comparative Trials:
methanesulfonic acid (D2.C1): (pK1=−1.9).
silylated ester of phosphoric acid (D2.C1): which is sold under the name “SOL 110” or “SOLUTION 110” by the company Bluestar Silicones (formerly Rhodia Silicones and earlier still Rhone-Poulenc Silicones). This stabilizer is mentioned for example in application US-2005-0282453 (page 12, paragraph [0268]) or international application WO1999005231 (page 13, line 13).

### Example 1

### Inhibitor (D1.I1): 1-ethynyl-1-cyclohexanol (ECH)

Compositions are prepared from the components listed in the following Table 1:

TABLE 1

| | Com- | Com- | Com- | Com- | Com- |
|---|---|---|---|---|---|
| | position | position | position | position | position |
| | (I-1) | (1-2) | (C-1) | (C-2) | (C-2a) |
| Vinylated | 3.80 | 3.80 | 3.80 | 3.80 | 3.80 |
| polydimethyl- | | | | | |
| siloxane oil (A.1) | | | | | |
| [mmol] | | | | | |
| Polymethylhydrogeno- | 6.84 | 6.84 | 6.84 | 6.84 | 6.84 |
| siloxane oil (B.1) | | | | | |
| [mmol] | | | | | |
| Catalyst (C) [mmol] | 0.0014 | 0.0014 | 0.0014 | 0.0014 | 0.0014 |
| Inhibitor ECH | 0.12 | 0.12 | 0.12 | 0.12 | 0.12 |
| (D1.I1) [mmol] | | | | | |
| acid (D2.I1) [mmol] | 0.045 | 0 | 0 | 0 | 0 |
| acid (D2.I2) [mmol] | 0 | 0.045 | 0 | 0 | 0 |
| acid (D2.C1) [mmol] | 0 | 0 | 0.045 | 0 | 0 |
| acid (D2.C2) [mmol] | 0 | 0 | 0 | 0 | 0.045 |

TABLE 2
Molar ratio

| | |
|---|---|
| [hydrogen atom bonded to the silicon of | 1.8 |
| (B.1)]/[vinyl radicals bonded to the silicon in | |
| organopolysiloxane (A.1)] | |
| Inhibitor ECH (D1.I1)/[acid D2] | 2.7 |
| [acid D2]/[catalyst C] | 32.14 |
| [inhibitor ECH (D1.I1)]/[acid D2] | 2.7 |
| [inhibitor ECH (D1.I1)]/[catalyst C] | 86.42 |

### Procedure:

The inhibitor ECH (D1.I1) is added beforehand to vinylated polydimethylsiloxane oil (A.1). After homogenization of the mixture, the polymethylhydrogenosiloxane oil (B.1) is then introduced, followed by the acid to be tested, except for the composition (C-2), and finally the catalyst (C). A sample for each composition is collected and analyzed by DSC (“Differential Scanning calorimetry”, METLER type apparatus). The analysis is carried out in an aluminum dish and using a temperature ramp of 25 to 250° C. with a gradient of 10° C./min. The time necessary for crosslinking at ambient temperature and the bath life are also measured.

The thermal profiles, the characteristic data for the exothermic peaks (T ° C. onset, T ° C. peak and T ° C. endset) and the bath life are represented in the following Table 3.

TABLE 3
Results by DSC analysis

| | DeltaH | T ° C. | T ° C. | T ° C. | Bath life |
|---|---|---|---|---|---|
| | (J/g) | onset | peak | endset | at 25° C. |
| Composition | 47 | 109 | 113 | 114 | >48 h |
| (C-2) | | | | | |
| Composition | 48 | 93 | 98 | 99 | >48 h |
| (I-1) | | | | | |
| Composition | 47 | 83 | 88 | 91 | Between 12 |
| (I-2) | | | | | and 24 h |
| Composition | 44 | 72 | 79 | 83 | 1 h |
| (C-1) | | | | | |
| Composition | 5 | 85 | 90 | 96 | >48 h |
| (C-2a) | | | | | |

It is observed that the life of the composition (C-1) which corresponds to the addition of an acid having a pKa of −1.9 does not make it possible to obtain a sufficient stability for industrial use.

For the composition (C-2bis), it is observed that the value of the heat of reaction measured is 5 J/g DeltaH (Table 3) much less than all the compositions tested. Indeed, for this composition, the crosslinking is incomplete, which does not make it possible to obtain a crosslinked coating.

On the other hand, the addition of acids according to the invention makes it possible to obtain satisfactory bath lives for industrial use. Furthermore, the lifting of inhibition is more rapid in the case where acids are present in the composition. If the lifting of inhibition of the compositions (I-1) and (I-2) is compared against the composition (C-1), the following are obtained:
for trifluoroacetic acid, compositions (I-1): ΔT peak=25° C., and
for heptanoic acid, compositions (I-2): ΔT peak=15° C.

### Example 2

### Inhibitor (D1.I1): 1-ethynyl-1-cyclohexanol (ECH)

Compositions are prepared from the components listed in the following Table 4 and following the same procedure as in Example 1.

TABLE 4

| | Composition | Composition | Composition | Composition | Composition | Composition |
|---|---|---|---|---|---|---|
| | (I-3) | (I-4) | (I-5) | (I-6) | (C-3) | (C-4) |
| Vinylated | 100 | 100 | 100 | 100 | 100 | 100 |
| polydimethylsiloxane | | | | | | |
| oil (A.2) [g] | | | | | | |
| Polymethylhydrogeno- | 7.5 | 7.5 | 7.5 | 7.5 | 7.5 | 7.5 |
| siloxane oil (B.2) | | | | | | |
| [g] | | | | | | |
| Catalyst (C) (ppm, | 50 | 50 | 50 | 50 | 50 | 50 |
| weight/total weight | | | | | | |
| of the composition) | | | | | | |
| Inhibitor ECH | 1500 | 1500 | 1500 | 1500 | 1500 | 1500 |
| (D1.I1) (ppm, | | | | | | |
| weight/total weight | | | | | | |
| of the composition) | | | | | | |
| acid (D2.I1) (ppm, | 1000 | 0 | 0 | 0 | 0 | 0 |
| weight/total weight | | | | | | |
| of the composition) | | | | | | |
| acid (D2.I2) (ppm, | 0 | 1000 | 0 | 0 | 0 | 0 |
| weight/total weight | | | | | | |
| of the composition) | | | | | | |
| acid (D2.I3) (ppm, | 0 | 0 | 1000 | 0 | 0 | 0 |
| weight/total weight | | | | | | |
| of the composition) | | | | | | |
| acid (D2.I4) (ppm, | 0 | 0 | 0 | 1000 | 0 | 0 |
| weight/total weight | | | | | | |
| of the composition) | | | | | | |
| acid (D2.C1) (ppm, | 0 | 0 | 0 | 0 | 1000 | 0 |
| weight/total weight | | | | | | |
| of the composition) | | | | | | |

Molar ratio [H/Vinyl] = 1.8

A sample for each composition is collected and analyzed by DSC (“Differential Scanning calorimetry”, METLER type apparatus). The analysis is carried out in an aluminum dish and using a temperature ramp from 30 to 200° C. with a gradient of 10° C./min. The time necessary for the crosslinking at ambient temperature and the bath life at 25° C. and 40° C. are also measured.

The thermal profiles, the characteristic data for the exothermic peaks (T ° C. onset, T ° C. peak and T ° C. endset) and the bath life are represented in the following Table 5.

TABLE 5
Results by DSC analysis

| | | T | | | Bath | Bath |
|---|---|---|---|---|---|---|
| | DeltaH | ° C. | T ° C. | T ° C. | life at | life at |
| | (J/g) | onset | peak | endset | 25° C. | 40° C. |
| Composition | 44 | 99 | 104 | 107 | 24 h | 7 h |
| (C-4) | | | | | | |
| Composition | 39 | 94 | 99 | 103 | 24 h | 7 h |
| (I-4) | | | | | | |
| Composition | 42 | 90 | 95 | 101 | 24 h | 7 h |
| (I-5) | | | | | | |
| Composition | 45 | 87 | 92 | 97 | 24 h | Between |
| (I-6) | | | | | | 4 and |
| | | | | | | 5 h |
| Composition | 41 | 75 | 82 | 91 | Not | 1 h |
| (I-3) | | | | | measured | |
| Composition | 38 | 72 | 80 | 93 | <1 h | <30 min |
| (C-3) | | | | | | |

It is observed that the life of the composition (C-3) at 25° C. and 40° C., which corresponds to the addition of an acid having a pKa of −1.9 does not make it possible to obtain a sufficient stability for industrial use.

On the other hand, the addition of acids according to the invention makes it possible to obtain satisfactory bath lives for industrial use. Furthermore, the lifting of inhibition is more rapid in the case where acids are present in the compositions.

It is observed that the best compromise between bath stability and reduction in the temperature for lifting of inhibition (acceleration of the crosslinking speed) is obtained with heptanoic acid (D2.I2) and orthophosphoric acid (D2.I3).

### Example 3

### Inhibitor (D1.I3) 2-methyl-3-butyn-2-ol (MBT)

Compositions are prepared from the components listed in the following Table 6:

TABLE 6

| | Com- | Com- | Com- | Com- |
|---|---|---|---|---|
| | position | position | position | position |
| | (I-7) | (I-8) | (I-9) | (C-5) |
| Vinylated | 3.80 | 3.80 | 3.80 | 3.80 |
| polydimethyl- | | | | |
| siloxane oil (A.1) | | | | |
| [mmol] | | | | |
| Polymethylhydrogeno- | 6.84 | 6.84 | 6.84 | 6.84 |
| siloxane oil (B.1) | | | | |
| [mmol] | | | | |
| Catalyst (C) | 0.0014 | 0.0014 | 0.0014 | 0.0014 |
| Inhibitor (D1.I3) | 0.484 | 0.484 | 0.484 | 0.484 |
| (MBT) [mmol] | | | | |
| acid (D2.I1) [mmol] | 0.045 | 0 | 0 | 0 |
| acid (D2.I2) [mmol] | 0 | 0.045 | 0 | 0 |
| acid (D2.I3) [mmol] | 0 | 0 | 0.045 | 0 |

The compositions are prepared according to the procedure described in Example 1.

The thermal profiles, the characteristic data for the exothermic peaks (T ° C. onset, T ° C. peak and T ° C. endset) and the bath life are represented in the following Table 7.

TABLE 7
Results by DSC analysis

| | deltaH | T ° C. | T ° C. | T ° C. | Bath life |
|---|---|---|---|---|---|
| | (J/g) | onset | peak | endset | at 25° C. |
| Composition | 51 | 97 | 101 | 104 | Between 20 |
| (C-5) | | | | | and 24 h |
| Composition | 47 | 88 | 94 | 97 | Between 20 |
| (I-9) | | | | | and 24 h |
| Composition | 48 | 85 | 89 | 92 | Between 20 |
| (I-8) | | | | | and 24 h |
| Composition | 46 | 78 | 83 | 85 | Between 20 |
| (I-7) | | | | | and 24 h |

With the compositions according to the invention (I-7) to (I-9), we indeed obtain a reduction in the temperature for lifting of inhibition (acceleration of the crosslinking speed) without deterioration in the bath life at 25° C.

### Example 4

### Inhibitor (D1.I2): 3,7,11-trimethyl-1-dodecyn-3-ol (TMDDO)

Compositions are prepared from the components listed in the following Table 8:

TABLE 8

| | Com- | Com- | Com- | Com- |
|---|---|---|---|---|
| | position | position | position | position |
| | (I-10) | (I-11) | (I-12) | (C-6) |
| Vinylated | 3.80 | 3.80 | 3.80 | 3.80 |
| polydimethyl- | | | | |
| siloxane oil (A.1) | | | | |
| [mmol] | | | | |
| Polymethylhydrogeno- | 6.84 | 6.84 | 6.84 | 6.84 |
| siloxane oil (B.1) | | | | |
| [mmol] | | | | |
| Catalyst (C) [mmol] | 0.0014 | 0.0014 | 0.0014 | 0.0014 |
| Inhibitor (D1.I2) | 0.121 | 0.121 | 0.121 | 0.121 |
| (TMDDO) [mmol] | | | | |
| acid (D2.I1) [mmol] | 0.045 | 0 | 0 | 0 |
| acid (D2.I2) [mmol] | 0 | 0.045 | 0 | 0 |
| acid (D2.I3) [mmol] | 0 | 0 | 0.045 | 0 |

The compositions are prepared according to the procedure described in Example 1.

The thermal profiles, the characteristic data for the exothermic peaks (T ° C. onset, T ° C. peak and T ° C. endset) and the bath life are represented in the following Table 9.

TABLE 9
Results by DSC analysis

| | deltaH | T ° C. | T ° C. | T ° C. | Bath life |
|---|---|---|---|---|---|
| | (J/g) | onset | peak | endset | at 25° C. |
| Composition | 47 | 123 | 125 | 126 | >48 h |
| (C-6) | | | | | |
| Composition | 48 | 119 | 123 | 123 | >48 h |
| (I-12) | | | | | |
| Composition | 48 | 116 | 119 | 120 | >48 h |
| (I-11) | | | | | |
| Composition | 48 | 112 | 115 | 117 | Between 20 |
| (I-10) | | | | | and 24 h |

With the compositions according to the invention (I-11) to (I-12), we indeed obtain a reduction in the temperature for lifting of inhibition and thus an acceleration of the crosslinking speed while obtaining bath lives similar to the reference or acceptable composition (composition (I-10)) for industrial use.

### Example 5

### Comparative inhibitor diallyl maleate (DAM) (D1.C1)

The composition (I-1) described in Table 1 was prepared according to Example 1, replacing in the same quantities the inhibitor ECH (D1.I1) with the inhibitor (D1.C1): diallyl maleate (DAM)=>Composition (C-7). This composition (C-7) is compared to the composition (C-2) (reference without addition of acid) described in Example 1.

The thermal profiles, the characteristic data for the exothermic peaks (T ° C. onset, T ° C. peak and T ° C. endset) are represented in the following Table 10.

TABLE 10
Results by DSC analysis

| | deltaH | T ° C. | T ° C. | T ° C. |
|---|---|---|---|---|
| | (J/g) | onset | peak | endset |
| Composition (C-2) | 51 | 108 | 115 | 118 |
| Composition (C-7) | 49 | 107 | 114 | 117 |

Contrary to the preceding trials with α-acetylenic alcohols, the addition of acid to polyaddition compositions comprising DAM as retardant does not make it possible to reduce the temperature for the lifting of inhibition.

### Example 6

### Inhibitor tetramethyltetravinylcyclotetrasiloxane (D₄^{vi})(D1.C2):

The composition (I-1) described in Table 1 was prepared according to Example 1, replacing in the same quantities the inhibitor ECH (D1.I1) with the inhibitor (D1.C2): D₄^{vi}=>Composition (C-8). This composition (C-8) is compared to the composition (C-2) (reference without addition of acid) described in Example 1.

The thermal profiles, the characteristic data for the exothermic peaks (T ° C. onset, T ° C. peak and T ° C. endset) are represented in the following Table 11.

TABLE 11
Results by DSC analysis

| | deltaH | T ° C. | T ° C. | T ° C. |
|---|---|---|---|---|
| | (J/g) | onset | peak | endset |
| Composition (C-2) | 46 | 73 | 101 | 118 |
| Composition (C-7) | 73 | 76 | 103 | 120 |

Like for the trial with DAM (Example 5), the addition of acid to polyaddition compositions comprising D₄^{vi} as retardant does not make it possible to reduce the temperature for the lifting of inhibition. The good results obtained are therefore limited to the formulations incorporating an α-acetylenic alcohol as retardant.

1. A method of coating on a flexible support S of a silicone composition X that is a precursor for an elastomer and that is crosslinkable by polyaddition reactions comprising the following steps a), b) and c):
a) preparing a silicone composition X that is crosslinkable to an elastomer by a polyaddition reaction, comprising:
(1) at least one organopolysiloxane A comprising per molecule at least two alkenyl radicals bonded to silicon atoms,
(2) at least one organohydrogenopolysiloxane B comprising per molecule at least two hydrogen atoms bonded to silicon atoms,
(3) at least one catalyst C comprising at least one metal belonging to the platinum group,
(4) at least one inhibitor D which is capable of being obtained by mixing, optionally in situ:
at least one inhibitor D1 which is an α-acetylenic alcohol of formula (I):
(R¹)(R²)C(OH)—C≡CH (1)
the radicals R¹ and R², which are identical or different, represent, independently of each other, a linear or branched monovalent alkyl group, a cycloalkyl group, a (cycloalkyl)alkyl group, an aromatic group or an arylalkyl group, and
the radicals R¹ and R² may be bonded two by two so as to form a 5-, 6-, 7- or 8-membered aliphatic ring optionally substituted with one or more substituents, and
at least one acid D2 which exhibits in aqueous solution at 25° C. at least a pKa whose value is within the following interval −0.9≦pKa≦+6.5,
said constituents D1 and D2 being initially present in said silicone composition X in sufficient quantities to:
maintain the inhibition of the catalyst C so as to avoid the formation of a gel or of an elastomer when said silicone composition X is stored at ambient temperature, and
allow the partial or complete degradation of said acetylenic alcohol D1 by a chemical reaction between the inhibitor D1 and the acid D2 when the silicone composition X is hardened by heating to a temperature greater than 60° C., and
on condition that said silicone composition X does not contain water or enough water so as not to exist in the form of an aqueous silicone dispersion or emulsion,
b) depositing said silicone composition X continuously or batchwise on said flexible support S, and
c) crosslinking the silicone composition X by heating to a temperature greater than 60° C., optionally from 70° C. to 200° C.

2. The coating method as claimed in claim 1, wherein said flexible support S comprises paper, textile, cardboard, metal or plastic.

3. The coating method as claimed in claim 1, wherein said flexible support S comprises textile, paper, polyvinyl chloride (PVC), polyester, polypropylene, polyamide, polyethylene, polyurethane, unwoven glass fiber tissues or polyethylene terephthalate (PET).

4. The coating method as claimed in claim 1, wherein said acid D2 is an acid exhibiting in aqueous solution and at 25° C. at least a pKa having a value within the following interval: 0≦pKa≦5.5 and optionally at least a pKa having a value within the following interval: 1≦pKa≦5.5.

5. The coating method as claimed in claim 1, wherein a molar ratio of inhibitor D1/acid D2 is from 0.1 to 10, optionally from 0.5 to 5.

6. The coating method as claimed in claim 1, wherein a molar ratio of inhibitor D1/catalyst C is from 10 to 60 and a molar ratio of acid D2/catalyst C is from 10 to 60.

7. The coating method as claimed in claim 1, wherein the acetylenic alcohol D1 is selected from the group consisting of the following compounds:
1-ethynyl-1-cyclopentanol; 1-ethynyl-1-cyclohexanol; 1-ethynyl-1-cycloheptanol; 1-ethynyl-1-cyclooctanol; 3-methyl-1-butyn-3-ol; 3-methyl-1-pentyn-3-ol; 3-methyl-1-hexyn-3-ol; 3-methyl-1-heptyn-3-ol; 3-methyl-1-octyn-3-ol; 3-methyl-1-nonyl-3-ol; 3-methyl-1-decyn-3-ol; 3-methyl-1-dodecyn-3-ol; 3-ethyl-1-pentyn-3-ol; 3-ethyl-1-hexyn-3-ol; 3-ethyl-1-heptyn-3-ol; 3-butyn-2-ol; 1-pentyn-3-ol; 1-hexyn-3-ol; 1-heptyn-3-ol; 5-methyl-1-hexyn-3-ol; 3,5-dimethyl-1-hexyn-3-ol; 3-isobutyl-5-methyl-1-hexyn-3-ol; 3,4,4-trimethyl-1-pentyn-3-ol; 3-ethyl-5-methyl-1-heptyn-3-ol; 4-ethyl-1-octyn-3-ol; 3,7,11-trimethyl-1-dodecyn-3-ol; 1,1-diphenyl-2-propyn-1-ol and 9-ethynyl-9-fluorenol.

8. The coating method as claimed in claim 1, in which the acid D2 is selected from the group consisting of acids exhibiting in aqueous solution and at 25° C. at least a pKa whose value is within the following interval: −0.9≦pKa≦+6.5 and from the group consisting of carboxylic acids, sulfonic acids and phosphoric acids.

9. The coating method as claimed in claim 7, in which said acid D2 is selected from the group consisting of: methanoic acid, orthophosphoric acid, heptanoic acid, trifluoroacetic acid and malonic acid.

10. The coating method as claimed in claim 1, wherein proportions of said organopolysiloxane A and of said organohydrogenopolysiloxane B are such that a molar ratio between the hydrogen atoms bonded to the silicon in said organohydrogenopolysiloxane B on the alkenyl radicals bonded to the silicon in said organopolysiloxane A is from 0.4 to 10.

11. The coating method as claimed in claim 1, wherein in b), a quantity of from 0.1 to 5 g/m² of said silicone composition X is deposited on said flexible support S.
